(19) United States
(12) Patent Application Publication
(10) Pub. No.: US 2025/0245589 A1
(43) Pub. Date: Jul. 31, 2025

(54) System and Method for Parts Usage and Replacement Forecasting

(71) Applicant: HITACHI, Ltd., Chiyoda-ku, Tokyo (JP)

(72) Inventors: Manish GUPTA, Sunnyvale, CA (US); Umeshwar DAYAL, Saratoga, CA (US); Sadanori HORIGUCHI, San Jose, CA (US); Dipanjan GHOSH, Santa Clara, CA (US)

(21) Appl. No.: 18/422,363

(22) Filed: Jan. 25, 2024

(51) Int. Cl. G06Q 10/0631; G06Q 30/0202

(52) U.S. Cl. CPC G06Q 10/06315; G06Q 30/0202

(57) ABSTRACT

A method for performing replacement forecasting, the method comprising generating, by a processor, a set of usage forecasts of a component associated with a machine owned by a customer; characterizing, by the processor, replacement behavior of the customer to generate predicted replacement usage level; generating, by the processor, replacement period forecast using the set of usage forecasts and the predicted replacement usage level; and generating, by the processor, replacement forecast for the component using the replacement period forecast.

### BACKGROUND

### Field

The present disclosure is generally directed to a method and a system for performing replacement forecasting.

### Related Art

Extending useful lives of products and materials through RE-processes (remanufacturing, refurbishment, repair, reuse/repurpose, and recycling) is a key tenet of Circular Economy. For products which have high post-use residual values, remanufacturing provides immense economic and environmental benefits by enabling a new service life at the products' end-of-use stage. Many complex industrial products, such as construction equipment, have manufacturer-specified operating lives for certain parts/components, after which the parts/components need to be replaced to ensure functioning of the products. Such used parts can be remanufactured to having quality and robustness similar to those of new parts. Manufacturers, therefore, engage in remanufacturing and offer the remanufactured parts as more economical option for periodic maintenance. Customers and product owners benefit from using remanufactured parts given that they are a fraction of the cost of new parts.

For remanufacturers, supply-chain management is much more complex than new product manufacturing as the demand and supply are intertwined and circular. Good demand forecasts become critical for remanufacturers to optimize their inventory (of cores, components, and finished products) and perform production planning. Insufficient inventory can result in demand loss, delayed fulfillment, or the need to acquire new parts as substitutions, which can lead to increased costs. Excess inventory, on the other hand, ties-up working capital and increases operational expenses.

Variability in demand introduces inefficiencies in the operations of the remanufacturer and affects inventory management, logistics, production planning, and financial planning. At the dealership level, in the absence of good demand forecasts from customers, the dealers need to lean towards overstocking, which ties up working capital. If the dealers do not have sufficient stock when demand comes, they need to either opt for rushed deliveries which can increase logistics costs (e.g. air freight) or risk delaying fulfillment, which affects customer operations and satisfaction.

At the regional level, the regional operations and distributors need to stock parts for multiple machines. Lack of demand forecasts makes inventory management and order planning inefficient. For parts that are remanufactured locally within the region, production planning and core return forecasting are particularly challenging. At the global level, the original equipment manufacturer (OEM) needs to plan production of parts and financial allocation for regional inventory and production planning. Not having a good understanding of future demands makes planning and inventory allocation inefficient.

In the related art, a method for performing demand forecast using historical data is disclosed. The method works at an aggregate level, particularly when there are discernable patterns like trends and seasonality in the data, when data is not sparse, or when the demand at an aggregate level is correlated with another set of easily measurable variables (e.g. economic indices, etc.) However, the method is incapable of generating accurate demand forecasts when there is high random variability in the historical data or the underlying factors influencing the demand are unknown. Furthermore, the method does not provide demand information at a finer granularity (e.g., on a per machine basis, etc.)

In the related art, a condition-based replacement method that does not utilize time-based/usage-based replacement factors in replacement determination is disclosed. However, the method requires building of good predictive models of equipment and parts' conditions, which requires a large amount of data to be processed for a number of parts. Additionally, failure data of the parts are often difficult to come by and is needed in order to improve accuracy.

In the related art, a method for ascertaining parts per machine needs based on usage information is disclosed. However, the method is restricted to extrapolating current usage to a future period, and does not take customer behavior into account. The method may work for short, near-term periods, but performs poorly for mid-to longer-term planning horizons where usage patterns may change.

### SUMMARY

Aspects of the present disclosure involve an innovative method for performing replacement forecasting. The method may include generating, by a processor, a set of usage forecasts of a component associated with a machine owned by a customer; characterizing, by the processor, replacement behavior of the customer to generate predicted replacement usage level; generating, by the processor, replacement period forecast using the set of usage forecasts and the predicted replacement usage level; and generating, by the processor, replacement forecast for the component using the replacement period forecast.

Aspects of the present disclosure involve an innovative non-transitory computer readable medium, storing instructions for performing replacement forecasting. The instructions may include performing generating, by a processor, a set of usage forecasts of a component associated with a machine owned by a customer; characterizing, by the processor, replacement behavior of the customer to generate predicted replacement usage level; generating, by the processor, replacement period forecast using the set of usage forecasts and the predicted replacement usage level; and generating, by the processor, replacement forecast for the component using the replacement period forecast.

Aspects of the present disclosure involve an innovative server system for performing replacement forecasting. The system may include generating, by a processor, a set of usage forecasts of a component associated with a machine owned by a customer; characterizing, by the processor, replacement behavior of the customer to generate predicted replacement usage level; generating, by the processor, replacement period forecast using the set of usage forecasts and the predicted replacement usage level; and generating, by the processor, replacement forecast for the component using the replacement period forecast.

Aspects of the present disclosure involve an innovative system for performing replacement forecasting. The system may include means for generating a set of usage forecasts of a component associated with a machine owned by a customer; means for characterizing replacement behavior of the customer to generate predicted replacement usage level; means for generating replacement period forecast using the set of usage forecasts and the predicted replacement usage level; and means for generating replacement forecast for the component using the replacement period forecast.

### BRIEF DESCRIPTION OF DRAWINGS

A general architecture that implements the various features of the disclosure will now be described with reference to the drawings. The drawings and the associated descriptions are provided to illustrate example implementations of the disclosure and not to limit the scope of the disclosure. Throughout the drawings, reference numbers are reused to indicate correspondence between referenced elements.

FIG. 1 illustrates an example forecast summary table 100 showing forecast needs at different levels of the distribution chain.

FIG. 2 illustrates difficulties and challenges of part usage estimation and replacement forecast generation.

FIG. 3 illustrates an example block diagram of a system utilizing a parts usage and replacement forecasting system 316, in accordance with an example implementation.

FIG. 4 illustrates an example process flow 400 of the parts usage and replacement forecasting system 316, in accordance with an example implementation.

FIG. 5 illustrates an example aggregation display 500 of parts usage and replacement forecasts at various levels, in accordance with am example implementation.

FIG. 6 illustrates a part usage and replacement forecast diagram 600, in accordance with an example implementation.

FIG. 7 illustrates an example diagram 700 showing application of the parts usage and replacement forecasting system 316, in accordance with an example implementation.

FIG. 8 illustrates an example process 800 for method for performing replacement forecasting, in accordance with an example implementation.

FIG. 9 illustrates an example computing environment with an example computer device suitable for use in some example implementations.

### DETAILED DESCRIPTION

The following detailed description provides details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of the ordinary skills in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

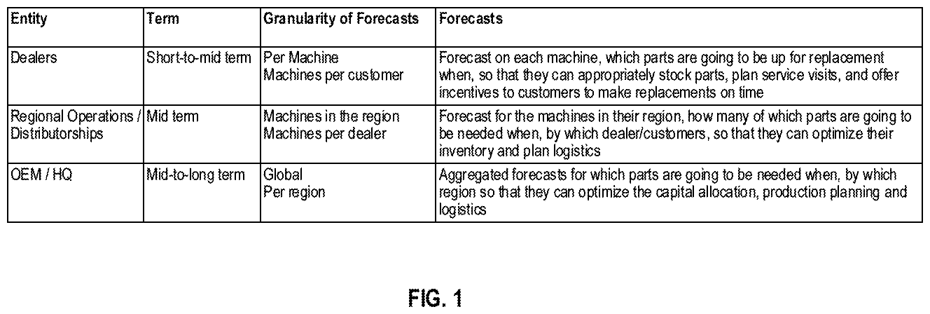

FIG. 1 illustrates an example forecast summary table 100 showing forecast needs at different levels of the distribution chain. As shown in FIG. 1, dealers require short-to-midterm forecasts of replacement parts/components on a per machine basis. The machines are then aggregated on a per customer level in order to generate forecasts on parts/components needing to be replaced for maintenance service purpose on a per customer level.

At the regional level, the regional operators/distributors require mid-term forecasts of replacement parts/components needs of dealers within the region. The forecasts can then be used in optimizing regional inventory and regional logistics planning. At the global level, the OEM requires mid-to-long term forecasts of replacement parts/components needs of regional operators/distributors. These forecasts can then be used in optimizing capital allocation, production planning, and global logistics planning.

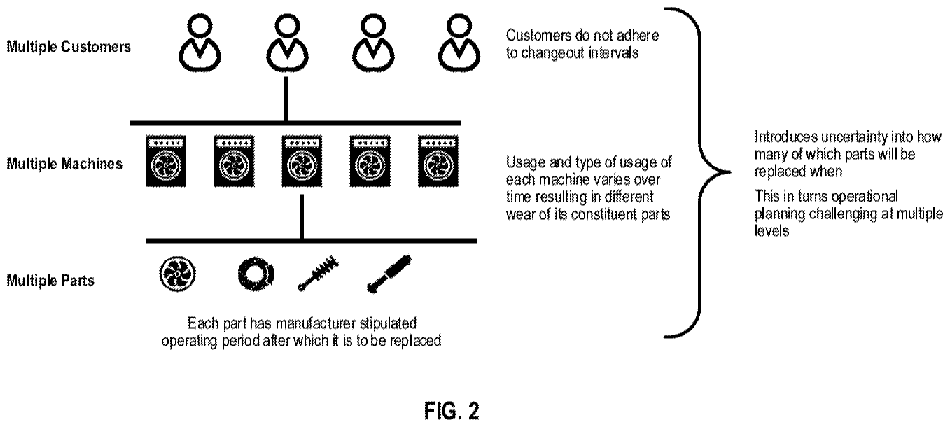

FIG. 2 illustrates difficulties and challenges of part usage estimation and replacement forecast generation. As illustrated in FIG. 2, a customer may have a number of machines and each machine may include a number of parts/components. For each part of the machine, there is a manufacturer stipulated operating period for which the part is to be replaced. However, the degree of use and usage type varies from one machine to another, which leads to different wear levels of parts across machines. For example, excavator A that stays stationary would have a different track wear level when compared to excavator B that moves around locations. On the customer level, customers do not adhere to manufacturer-specified or agreed upon parts replacement intervals, which introduces variability in the demand for parts and renders replacement forecasting particularly challenging.

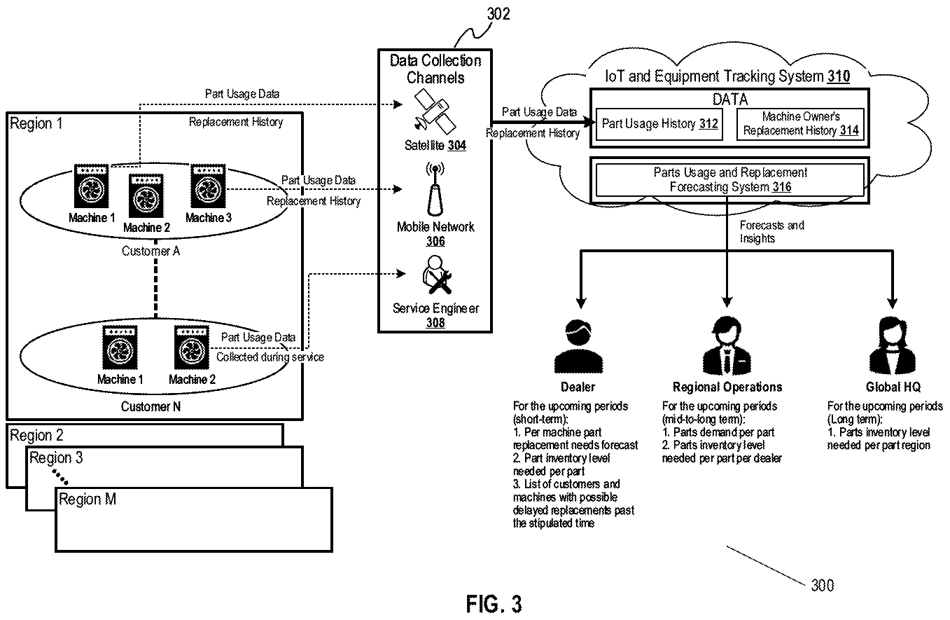

FIG. 3 illustrates an example block diagram of a system 300 utilizing a parts usage and replacement forecasting system 316, in accordance with an example implementation. The parts usage and replacement forecasting system 316 factors in two primary aspects: usage of equipment over time and customer behavior.

Usage of equipment: For each machine, the duty-cycles/run-time varies considerably over time. The usage of the constituent parts of the machine may be the same as the machine's overall usage or may be different (more or less). For instance, for a particular type of product, a cooling system may only operate when a thermal outage happens on a machine and hence the usage of the cooling system may be different from the usage of the machine itself. Using sensors and Internet of Things (IoT) devices, the machines capture and communicate usage information periodically with an IoT and equipment tracking system 310 through various data collection channels 302. Such data collection channels 302 may include, but not limited to, satellite 304, network 306 (e.g. wired, wireless, mobile, etc.), service engineer providing onsite service 308, etc. The data collected (usage information) is then stored as part usage history 312 on the IoT and equipment tracking system 310. The IoT and equipment tracking system 310 may operate on a server or over the cloud.

In some example implementations, the communicated information may include information on usage of specific functions of the equipment/machine and associated parts (such as when a particular component was started and stopped). In some example implementations, the machine may only communicate usage information for the machine itself and does not include usage information of the associated parts. In this scenario, the machine's usage information may serve as proxy for the usage information of the parts. Based on the type of product and its configuration, the information may be communicated near-real-time or in batches.

Customer behavior: The part replacement periods are typically manufacturer specified. For instance, for a particular type of equipment the manufacturer may specify that a part is to be replaced after 10,000 hours of use, akin to how a car manufacturer may specify transmission oil changes every 75,000 miles. In some cases, the manufacturer and the customer may agree on different part change intervals for specific parts of a machine based on degree of usage. For instance, car manufacturers may request that transmission oil changes be done every 50,000 miles instead of 75,000 miles for cars operating in particularly difficult terrain or harsh environment. However, the equipment owners may not abide by or adhere to the manufacturer specified or agreed upon part replacement intervals. Equipment owners have the tendency to overuse parts and replace them at a time later than the specified period or agreed upon interval. In rare cases, the equipment owners may underuse the parts and replace them ahead of the specified period or agreed upon interval. This variability may stem from economic reasons of the equipment owners (e.g. market downturn leading to delayed maintenance, etc.) Information on part replacements are recorded and stored as machine owner's replacement history 314 on the IoT and equipment tracking system 310. Historical replacement information such as service events, part identifier, and actual replacement time associated with various replaced parts are available in the machine owner's replacement history 314, which is maintained by the OEM. The information contained in the part usage history 312 and the machine owner's replacement history 314 are then utilized by the parts usage and replacement forecasting system 316 in generating replacement forecasts at various levels (e.g. dealers, regional operations, global HQ, etc.)

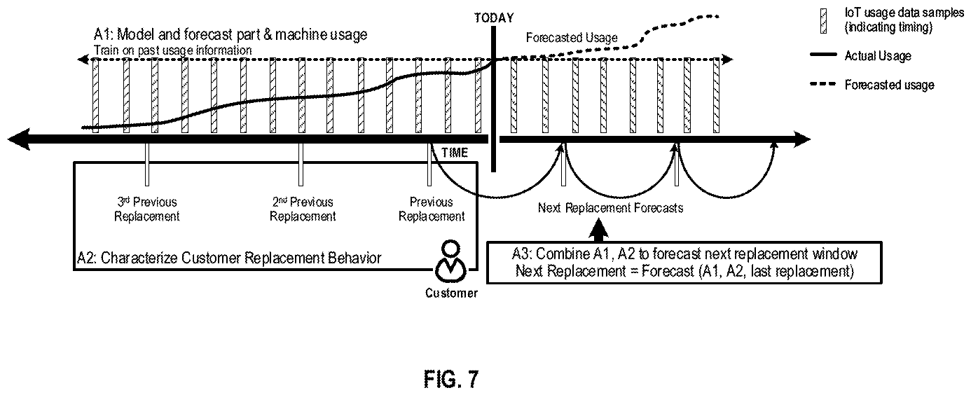

FIG. 7 illustrates an example diagram 700 showing application of the parts usage and replacement forecasting system 316, in accordance with an example implementation. As illustrates in FIG. 7, part and machine usage are modeled and forecasted (A1). The modeled and forecasted part and machine usage in conjunction with characterized customer replacement behavior (A2) generate a forecasted window/time period for the next part/component replacement (A3).

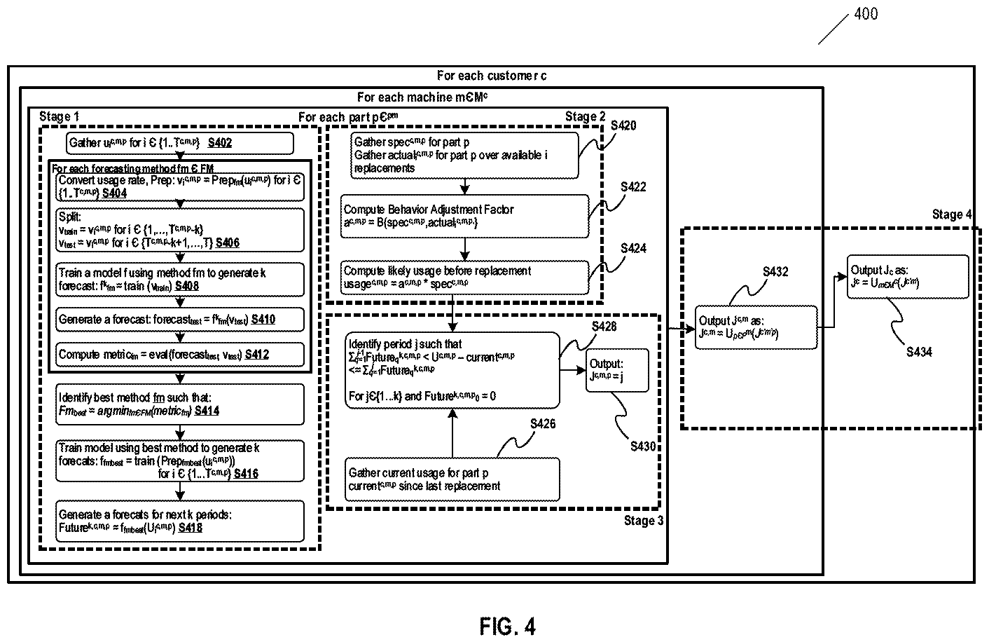

FIG. 4 illustrates an example process flow 400 of the parts usage and replacement forecasting system 316, in accordance with an example implementation. As part of the process flow 400, the following notations and assumptions are used:
C is the set of customers.
M is the set of all the machines operating in the field with the set of customers C.
P is the set of parts that need to be periodically replaced across the machines.
M_{c} is the set of machines belonging to a customer c, with c∈C, M_{c}∈M.
Pₘ is the set of parts that need to be periodically replaced on machine m, with m∈M^{c}, P^{m}∈P.
spec^{c,m,p} is the agreed upon replacement interval for part p for machine m of customer c. In some example implementations, this may be the same as the manufacturer specified interval for part p on machine m.
r^{c,m,p} is the number of historical replacements as yet of part p for machine m with customer c.
actualᵢ^{c,m,p} is the actual replacement interval for i^{th} replacement of part p for machine m with customer c, with i∈{1, . . . , r^{c,m,p}}.
current^{c,m,p} is the current usage of the part p on machine m with customer c since the last replacement.
FM is the set of available time-series forecasting methods under consideration.
Prep^{fm} is the set of data preparation steps for method fm, fm∈FM. Prep^{fm} may include steps such as cleansing, data conversion and normalization that are specifically needed for method fm.
eval (forecast, actual) represents evaluation metric that compares forecasted and actual values.
T^{c,m,p} is the number of previous time periods for which historical usage rate of part p for machine m with customer c is available.
uᵢ^{c,m,p} is historical usage rate of part p for machine m with customer c for time period i, with i € {1, . . . , T^{c,m,p}].
B is the function to compute behavior adjustment factor given the specified part replacement interval and actual part replacement intervals.
k is the number of desired forecasting periods.
Future^{k,c,m,p} is the ordered set of k future usages of part p for machine m for customer cover j^{th} future period, with j∈{1, . . . k}.
usage^{c,m,p} is likely usage of part p on machine m by customer C of the current part before replacement.
J^{c,m,p} is the future period where the replacement of part p of machine m of customer c is likely to happen.
J^{c,m} is the set of future periods where the replacement of the parts of machine m of customer care likely to happen.
J^{c} is the set of future periods where the replacement of the parts for machines that below to customer c are likely to happen.

The parts usage and replacement forecasting system 316 implements a four-step approach. Step 1 models the historical run-time information as time-series and applies several time-series forecasting methods to accurately forecast the part usage over the upcoming periods. At stage 2, each customer's replacement behavior is individually characterized to account for customers' non-adherence to the specified periodic replacement intervals. By combining each part's forecasted run-time over the upcoming period and its owner's replacement behavior, part replacement in the upcoming periods can be forecasted at stage 3. Lastly, by aggregating potential parts needs across product units and regions, future parts demand estimation for dealers, regional operations and the OEM can be optimized. Stages 1-3 are executed for every part that requires usage-based replacement.

At stage 1 of the process flow 400, usage forecast is performed over part p of machine M over upcoming future periods k. Depending on the part, the usage rate may take various forms, including, but not limited to, duty cycle per period, distance per period, etc. If the total usage is available instead of usage rate, then the usage rate can be computed by taking first difference over a time period. In some example implementations, usage rate or usage data for an individual part/component may not be readily available. In such scenarios, machine usage data or machine usage rate may serve as proxy for part usage data or usage rate.

Time-series modeling is used in performing usage forecast. The modeling methods range from time-series forecasting methods (e.g. auto regressive integrated moving average (ARIMA), error trend and seasonality (ETS), simple exponential smoothing (SES), Prophet, etc.) to neural network models to ensembles that incorporate a number of different methods. In some example implementations, multiple time series methods are evaluated for different parts having different usage levels to identify a best suited method. Forecast performance of different methods may vary over future time periods, hence, a full evaluation is needed at each forecasting period. This then generates forecasted usage of a part per period for future periods.

At step S402, historical usage rate/historical usage information is gathered for each part p of machine M for the available time periods T_{c,m,p}(t observations)−uᵢ^{c,m,p} over i ∈{1, . . . , T^{c,m,p}} time periods. Steps S404-S412 are performed for each forecasting method fm ∈FM. At step S404, the usage rate is converted and represented in time series (vᵢ^{c,m,p.}) through Prep^{fm}, and is represented by:

vᵢ^{c,m,p}=Prep_{fm}(uᵢ^{c,m,p}) for i∈{1 . . . T^{c,m,p}}

At step S406, the time series (vᵢ^{c,m,p.}) is split into training series Vₜᵣₐᵢₙ (Vᵢ^{c,m,p.} for 1 . . . T^{c,m,p}−k historical observations) and testing series Vₜₑₛₜ (Vᵢ^{c,m,p.} for recent k observations). The split time series is represented by:

$${v}_{ttain} = {v}_{i}^{c , m , p} for i ∈ \{ 1 , … , {T}^{c , m , p} - k \}$$

$${v}_{t e s t} = {v}_{i}^{c , m , p} for i ∈ \{ {T}^{c , m , p} - k + 1 , … , T \}$$

The process then proceeds to step S408 where a model f is trained using the training series vₜᵣₐᵢₙ to generate k forecasts (f^{k}_{fm}=train (vₜᵣₐᵢₙ)). Then the model f^{k}_{fm} is used to generate test forecasts using recent k observation (forecastₜₑₛₜ=f^{k}_{fm} (vₜₑₛₜ)) at step S410. At step S412, model evaluation metric, metric_{fm}, is computed over the testing series and test forecasts. metric_{fm} is represented by:

metric_{fm}=eval(forecastₜₑₛₜ,vₜₑₛₜ)

The model evaluation metrics for the various analytics models across all forecasting methods fm∈FM are then compared to select the best/highest performing forecasting method fm_{best} at step S414, which is represented by:

fm_{best}=argmin_{fm∈FM}(metric_{fm})

The various analytics models may include one or more of machine learning (ML) models, statistical models, or deep learning models. The best/highest performing forecasting method is then trained on all T^{c,m,p} observations at step S416:

f_{fmbest}=train(Prep_{fm best}(uᵢ^{c,m,p})) for i∈{1 . . . T^{c,m,p}}

Finally, at step S418, the k forthcoming forecast periods (Future^{k,c,m,p}) are generated as usage forecasts. The historical usage rate/historical usage information serve as input to the best/highest performing forecasting method in generating the usage forecasts, and can be represented by:

Future^{k,c,m,p}=f_{fmbest}(Uᵢ^{c,m,p})

In some example implementations, the historical usage rate/historical usage information is preprocessed to generate preprocessed historical usage rate/historical usage information. The preprocessed historical usage rate/historical usage information is then used as input to the best/highest performing forecasting method in generating the usage forecasts.

At stage 2 of the process flow 400, customers' replacement behavior is characterized (replacement behavior characterization) based on their past replacement history to generate predicted replacement usage level. At step S420, historical replacement periods of customer C for part p and at least one of manufacturer stipulated replacement interval or customer agreed replacement interval for part p of customer C are gathered. The manufacturer stipulated or customer agreed replacement interval for part p of customer C is represented by spec^{c,m,p}. The historical replacement periods of customer C for part p on machine m is represented by actualᵢ^{c,m,p} over all available replacements r^{c,m,p}.

Behavior adjustment factor (α^{c,m,p}) is then computed using spec^{c,m,p} and actualᵢ^{c,m,p} as inputs at step S422, and is represented by:

α^{c,m,p}=B(spec^{c,m,p},actualᵢ^{c,m,p})

where B is the behavior adjustment function for computing the behavior adjustment factor. In some example implementations, the behavior adjustment factor can be derived by first computing part change interval ratios for the observations and then computing the median of the part change interval ratios. Part change interval ratio is derived by dividing actual replacement period by agreed upon replacement interval, and represented by:

actualᵢ^{c,m,p}/spec^{c,m,p} for i∈1 . . . r^{c,m,p}

In some example implementations, the behavior adjustment factor is at least one of the median of the part change interval ratios or estimated distribution of the part change interval ratios. For instance, if the part change interval ratios are normally distributed, then the mean of the distribution can be the behavior adjustment factor.

At step S424, likely usage before replacement (usage^{c,m,p}) is computed by multiplying the behavior adjustment factor (α^{c,m,p}) with the agreed replacement interval for part C (spec^{c,m,p}).

Ideally, use of replacement behavior of part p on machine m is desired. However, part/component replacement may not have happened for the specific part, which leads to insufficient or unavailable replacement data. In such cases, data from same or similar part across similar machines belonging to the same customer can be used in the characterization of customer replacement behavior.

At stage 3 of the process flow 400, outputs of steps 1 and 2 are combined with the current usage of the part to forecast the next replacement time period from the k periods. At step S426, current part usage since last replacement of part p (current^{c,m,p}) is gathered. At step S428, a target period j, in which usage of part p likely exceeds usage since last recorded replacement, is identified from the k periods. The forecasted usages over the next k periods from step 1 (Future^{k,c,m,p}) and likely usage before replacement from step 2 (usage^{c,m,p}) are combined with current part usage as derived from step S426 to identify the period j. The period j is the period in which part p of machine m of customer c is likely to be replaced, and can be identified through the following equation:

$${\sum }_{q = 1}^{j - 1} {Future}_{q}^{k , c , m , p} < {U}^{c , m , p} - {current}^{c , m , p} <= {\sum }_{q = 1}^{j} {Future}_{q}^{k , c , m , p}$$

For j∈{1 . . . k} and Future^{k,c,m,p}ₒ=0, J^{c,m,p}=j is outputted at step S430.

At stage 4, the forecasts are combined and aggregated at different levels to generate insights for different entities. For example:
Output J^{c,m} as: J^{c,m}=U_{p∈P}_{^{m}}(j^{c′m′p}) for machine m at step S432
Output J_{c} as: J_{c}=U_{m∈M}_{^{c}}(J^{c′m}) for customer c at step S434
   In some example implementations, notifications associated with the aggregated forecasts are generated and sent to the user/operator of the system whenever changes are detected on aggregated forecasts based on information update.

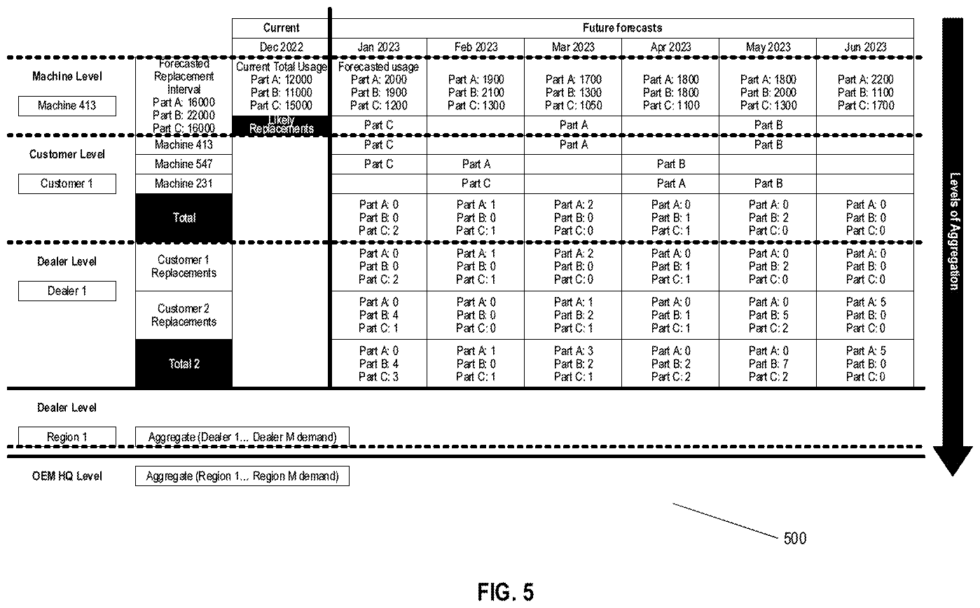

FIG. 5 illustrates an example aggregation display 500 of parts usage and replacement forecasts at various levels, in accordance with an example implementation. Parts replacement forecasts for per machine per customer can be generated by executing the various steps contained in FIG. 4. The aggregation display 500 may be accessed by the OEM through a graphical user interface (GUI) to determine replacement forecasts in the aggregate at different levels. The different levels may include, but not limited to, machine level, customer level, dealer level, regional level, and OEM level.

At the machine level, forecasted replacement intervals are determined for the various parts/components of the machines. As illustrated in FIG. 5, usage forecasts of parts A-C of a machine being identified as machine 413 are displayed. At the customer level, forecasted replacement intervals of parts associated with various machines owned by a common customer are determined and aggregated. As illustrated in FIG. 5, usage forecasts of parts A-C associated with commonly owned machines (e.g. machine 413, machine 547, and machine 231) are aggregated for the different forecasted replacement intervals. Such information can be used by a dealer and by customer service representative to recommend and schedule service events, offer deals on parts/service, and track and mitigate overages on parts.

At the dealer level, forecasted replacement intervals of parts associated with various machines owned by a number of customers of a dealer are determined and aggregated to generate dealer level part replacement forecast as part of maintenance support. As illustrated in FIG. 5, usage forecasts of parts A-C associated machines owned by customers (e.g. customer 1 and customer 2) of a dealer (dealer 1) are aggregated for the different forecasted replacement intervals. Such information can be used by a dealer to plan component inventory and component logistics.

At the regional level, forecasted replacement intervals of parts of dealers within regions managed by regional distributors are determined and aggregated to generate regional part replacement forecast. As illustrated in FIG. 5, usage forecasts of parts A-C for dealers (e.g. dealers 1-M) are aggregated for the different forecasted replacement intervals. Such information can be used by the regional distributors/operations to plan local production, regional component inventory, component ordering support, and regional component logistics.

At the OEM level, forecasted replacement intervals of parts various regions are determined and aggregated to generate manufacturer part replacement forecast. As illustrated in FIG. 5, usage forecasts of parts A-C for regions (e.g. regions 1-M) are aggregated for the different forecasted replacement intervals. Such information can be used by the OEM HQ to plan production, optimize global component inventory planning, and global component logistics.

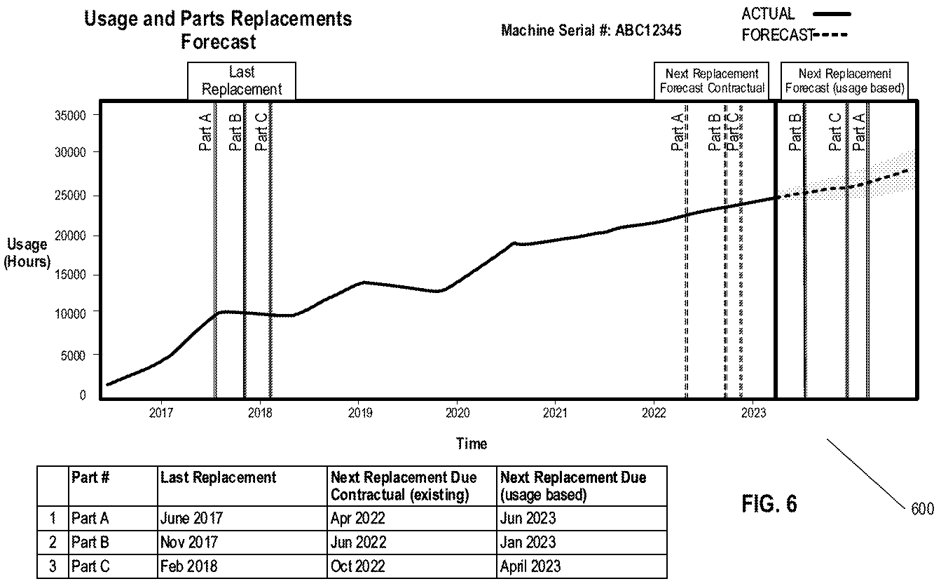

FIG. 6 illustrates a part usage and replacement forecast diagram 600, in accordance with an example implementation. The replacement forecast diagram 600 shows part usage and replacement forecasts for three parts, part A, part B, and part C. As illustrated in the FIG. 6, the parts were previous replaced between 2017 and 2018 at three different time periods. By performing replacement forecasts, part replacement needs can be accurately predicted based on usage and customer replacement behavior. The dotted lines represent manufacturer-specified or agreed upon part replacement periods, which does not take into account customer behavior and independent part usage. Adhering strictly to the dotted manufacturer-specified or agreed upon part replacement periods could result in insufficient inventory or excess inventory at different levels.

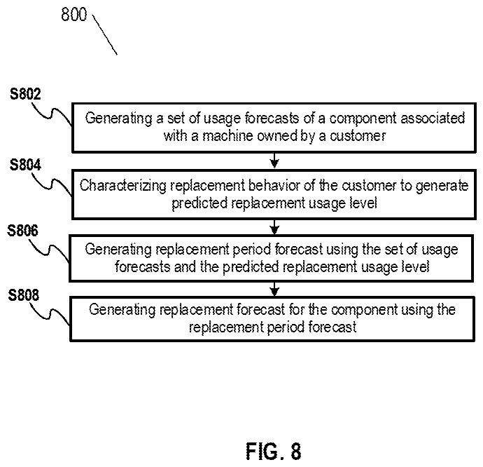

FIG. 8 illustrates an example process 800 for method for performing replacement forecasting, in accordance with an example implementation. The process begins at step S802 where a set of usage forecasts of a component associated with a machine owned by a customer is generated. Step S802 corresponds to process flow covered under stage 1 of FIG. 4. At step S804, replacement behavior of the customer is characterized to generate predicted replacement usage level. Step S804 corresponds to process flow covered under stage 2 of FIG. 4.

The process then continues to step S806 where replacement period forecast is generated using the set of usage forecasts and the predicted replacement usage level. Step S806 corresponds to process flow covered under stage 3 of FIG. 4. At step S808, replacement forecast for the component is generated using the replacement period forecast. Step S808 corresponds to process flow covered under stage 4 of FIG. 4.

The foregoing example implementation may have various benefits and advantages. For example, customers' replacement behavior as well as individual part usage are taken into consideration in part replacement forecast generation. Such insights help the operation planners of different levels to better understand customers' needs and optimize inventory accordingly. Part replacement forecast can be performed based on usage of each individual machine and its constituent parts to better capture associated duty cycles. In addition, example implementations complement condition-based approaches to forecast part replacements.

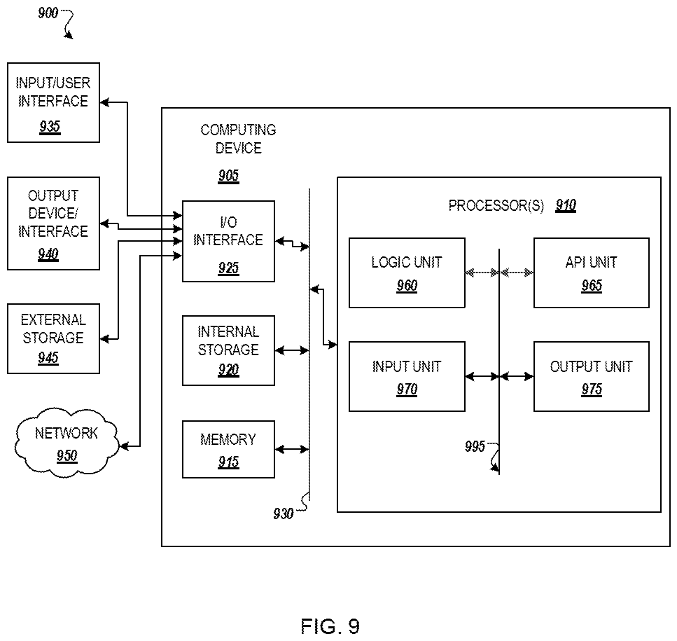

FIG. 9 illustrates an example computing environment with an example computer device suitable for use in some example implementations. Computer device 905 in computing environment 900 can include one or more processing units, cores, or processors 910, memory 915 (e.g., RAM, ROM, and/or the like), internal storage 920 (e.g., magnetic, optical, solid-state storage, and/or organic), and/or IO interface 925, any of which can be coupled on a communication mechanism or bus 930 for communicating information or embedded in the computer device 905. IO interface 925 is also configured to receive images from cameras or provide images to projectors or displays, depending on the desired implementation.

Computer device 905 can be communicatively coupled to input/user interface 935 and output device/interface 940. Either one or both of the input/user interface 935 and output device/interface 940 can be a wired or wireless interface and can be detachable. Input/user interface 935 may include any device, component, sensor, or interface, physical or virtual, that can be used to provide input (e.g., buttons, touch-screen interface, keyboard, a pointing/cursor control, microphone, camera, braille, motion sensor, accelerometer, optical reader, and/or the like). Output device/interface 940 may include a display, television, monitor, printer, speaker, braille, or the like. In some example implementations, input/user interface 935 and output device/interface 940 can be embedded with or physically coupled to the computer device 905. In other example implementations, other computer devices may function as or provide the functions of input/user interface 935 and output device/interface 940 for a computer device 905.

Examples of computer device 905 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 905 can be communicatively coupled (e.g., via IO interface 925) to external storage 945 and network 950 for communicating with any number of networked components, devices, and systems, including one or more computer devices of the same or different configuration. Computer device 905 or any connected computer device can be functioning as, providing services of, or referred to as a server, client, thin server, general machine, special-purpose machine, or another label.

IO interface 925 can include but is not limited to, wired and/or wireless interfaces using any communication or IO protocols or standards (e.g., Ethernet, 802.11x, Universal System Bus, WiMax, modem, a cellular network protocol, and the like) for communicating information to and/or from at least all the connected components, devices, and network in computing environment 900. Network 950 can be any network or combination of networks (e.g., the Internet, local area network, wide area network, a telephonic network, a cellular network, satellite network, and the like).

Computer device 905 can use and/or communicate using computer-usable or computer readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid-state media (e.g., RAM, ROM, flash memory, solid-state storage), and other non-volatile storage or memory.

Computer device 905 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 910 can execute under any operating system (OS) (not shown), in a native or virtual environment. One or more applications can be deployed that include logic unit 960, application programming interface (API) unit 965, input unit 970, output unit 975, and inter-unit communication mechanism 995 for the different units to communicate with each other, with the OS, and with other applications (not shown). The described units and elements can be varied in design, function, configuration, or implementation and are not limited to the descriptions provided. Processor(s) 910 can be in the form of hardware processors such as central processing units (CPUs) or in a combination of hardware and software units.

In some example implementations, when information or an execution instruction is received by API unit 965, it may be communicated to one or more other units (e.g., logic unit 960, input unit 970, output unit 975). In some instances, logic unit 960 may be configured to control the information flow among the units and direct the services provided by API unit 965, the input unit 970, the output unit 975, in some example implementations described above. For example, the flow of one or more processes or implementations may be controlled by logic unit 960 alone or in conjunction with API unit 965. The input unit 970 may be configured to obtain input for the calculations described in the example implementations, and the output unit 975 may be configured to provide an output based on the calculations described in example implementations.

Processor(s) 910 can be configured to generate a set of usage forecasts of a component associated with a machine owned by a customer as shown in FIGS. 4 and 8. The processor(s) 910 may also be configured to characterize replacement behavior of the customer to generate predicted replacement usage level as shown in FIGS. 4 and 8. The processor(s) 910 may also be configured to generate replacement period forecast using the set of usage forecasts and the predicted replacement usage level as shown in FIGS. 4 and 8. The processor(s) 910 may also be configured to generate replacement forecast for the component using the replacement period forecast as shown in FIGS. 4 and 8.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer readable storage medium or a computer readable signal medium. A computer readable storage medium may involve tangible mediums such as, but not limited to optical disks, magnetic disks, read-only memories, random access memories, solid-state devices, and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general-purpose computer, based on instructions stored on a computer readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method for performing replacement forecasting, the method comprising:
generating, by a processor, a set of usage forecasts of a component associated with a machine owned by a customer;
characterizing, by the processor, replacement behavior of the customer to generate predicted replacement usage level;
generating, by the processor, replacement period forecast using the set of usage forecasts and the predicted replacement usage level; and
generating, by the processor, replacement forecast for the component using the replacement period forecast.

2. The method of claim 1, wherein the processor is configured to perform replacement behavior characterization to generate the predicted replacement usage level by:
receiving stipulated replacement interval information;
computing a behavior adjustment factor of the customer; and
determining the predicted replacement usage level using the stipulated replacement interval information and the behavior adjustment factor.

3. The method of claim 2, wherein computing the behavior adjustment factor of the customer comprises:
receiving historical replacement interval information; and
deriving a plurality of part change interval ratios using the historical replacement interval information and the stipulated replacement interval information,
wherein the historical replacement interval information comprises a plurality of actual replacement periods associated with the component, and
wherein the behavior adjustment factor is determined from the plurality of part change interval ratios.

4. The method of claim 3,
wherein the behavior adjustment factor is at least one of median of the plurality of part change interval ratios or an estimated distribution of the plurality of part change interval ratios.

5. The method of claim 4, wherein the processor is configured to generate the set of usage forecasts of the component by:
receiving historical usage information of the component that comprises usage information over a plurality of observed time periods;
splitting the historical usage information into a set of training usage data and a set of testing usage data;
performing, for each of a plurality of forecasting models, model training using the set of training usage data to generate trained forecasting model;
performing, for each trained forecasting model, forecast generation using the set of testing usage data and computing evaluation metric;
comparing evaluation metrics to determine a highest performing trained forecasting model; and
receiving the historical usage information as input to the highest performing trained forecasting model to generate the set of usage forecasts,
wherein the set of usage forecasts comprises predicted future usage information associated with a plurality of future time periods.

6. The method of claim 5, wherein the historical usage information is preprocessed to generate preprocessed historical usage information, and the preprocessed historical usage information is used as input to the highest performing trained forecasting model to generate the set of usage forecasts.

7. The method of claim 5, wherein the plurality of forecasting models comprises analytics models that include one or more of machine learning (ML) models, statistical models, or deep learning models.

8. The method of claim 5, wherein the processor is configured to generate the replacement period forecast by:
generating the replacement period forecast by using the set of usage forecasts and the predicted replacement usage level to identify a target time period from the plurality of future time periods that predicted future usage of the component exceeds the predicted replacement usage level.

9. The method of claim 1,
wherein the replacement forecast and a plurality of replacement forecasts are combined to generate a dealer level part replacement forecast, and the dealer level part replacement forecast is received by a dealer and used by the dealer in performing optimization of component inventory planning and component logistics;
wherein the plurality of replacement forecasts is associated with a plurality of components of a plurality of machines owned by a plurality of customers; and
wherein the dealer provides maintenance support to the customer and the plurality of customers.

10. The method of claim 9,
wherein the dealer level part replacement forecast and a plurality of dealer level replacement forecasts are combined to generate a regional part replacement forecast, and the regional part replacement forecast is received by a regional distributor and used by the regional distributor in performing optimization of regional component inventory planning and regional component logistics;
wherein the plurality of dealer level replacement forecasts is associated with a plurality of dealers that provide maintenance service in areas different from an area associated with the dealer;
wherein the regional distributor provides component ordering support to the dealer and the plurality of dealers;
wherein the regional part replacement forecast and a plurality of regional replacement forecasts are combined to generate a manufacturer part replacement forecast, and the manufacturer part replacement forecast is received by a manufacturer and used by the manufacturer in performing optimization of global component inventory planning and global component logistics;
wherein the plurality of regional replacement forecasts is associated with a plurality of regional distributors that provide component ordering support in regions different from a region associated with the regional distributor; and
wherein the manufacturer provides components to the regional distributor and the plurality of regional distributors.

11. A system for performing replacement forecasting, the system comprising:
a machine owned by a customer;
a processor in communication with the machine, the processor is configured to:
generate a set of usage forecasts of a component associated with the machine;
characterize replacement behavior of the customer to generate predicted replacement usage level;
generate replacement period forecast using the set of usage forecasts and the predicted replacement usage level; and
generate replacement forecast for the component using the replacement period forecast.

12. The system of claim 11, wherein the processor is configured to perform replacement behavior characterization to generate the predicted replacement usage level by:
receiving stipulated replacement interval information;
computing a behavior adjustment factor of the customer; and
determining the predicted replacement usage level using the stipulated replacement interval information and the behavior adjustment factor.

13. The system of claim 12, wherein computing the behavior adjustment factor of the customer comprises:
receiving historical replacement interval information; and
deriving a plurality of part change interval ratios using the historical replacement interval information and the stipulated replacement interval information,
wherein the historical replacement interval information comprises a plurality of actual replacement periods associated with the component, and
wherein the behavior adjustment factor is determined from the plurality of part change interval ratios.

14. The system of claim 13,
wherein the behavior adjustment factor is at least one of median of the plurality of part change interval ratios or an estimated distribution of the plurality of part change interval ratios.

15. The system of claim 14, wherein the processor is configured to generate the set of usage forecasts of the component by:
receiving historical usage information of the component that comprises usage information over a plurality of observed time periods;
splitting the historical usage information into a set of training usage data and a set of testing usage data;
performing, for each of a plurality of forecasting models, model training using the set of training usage data to generate trained forecasting model;
performing, for each trained forecasting model, forecast generation using the set of testing usage data and computing evaluation metric;
comparing evaluation metrics to determine a highest performing trained forecasting model; and
receiving the historical usage information as input to the highest performing trained forecasting model to generate the set of usage forecasts,
wherein the set of usage forecasts comprises predicted future usage information associated with a plurality of future time periods.

16. The system of claim 15, wherein the historical usage information is preprocessed to generate preprocessed historical usage information, and the preprocessed historical usage information is used as input to the highest performing trained forecasting model to generate the set of usage forecasts.

17. The system of claim 15, wherein the plurality of forecasting models comprises analytics models that include one or more of machine learning (ML) models, statistical models, or deep learning models.

18. The system of claim 15, wherein the processor is configured to generate the replacement period forecast by:
generating the replacement period forecast by using the set of usage forecasts and the predicted replacement usage level to identify a target time period from the plurality of future time periods that predicted future usage of the component exceeds the predicted replacement usage level.

19. The system of claim 11,
wherein the replacement forecast and a plurality of replacement forecasts are combined to generate a dealer level part replacement forecast, and the dealer level part replacement forecast is received by a dealer and used by the dealer in performing optimization of component inventory planning and component logistics;
wherein the plurality of replacement forecasts is associated with a plurality of components of a plurality of machines owned by a plurality of customers; and
wherein the dealer provides maintenance support to the customer and the plurality of customers.

20. The system of claim 19,
wherein the dealer level part replacement forecast and a plurality of dealer level replacement forecasts are combined to generate a regional part replacement forecast, and the regional part replacement forecast is received by a regional distributor and used by the regional distributor in performing optimization of regional component inventory planning and regional component logistics;
wherein the plurality of dealer level replacement forecasts is associated with a plurality of dealers that provide maintenance service in areas different from an area associated with the dealer;
wherein the regional distributor provides component ordering support to the dealer and the plurality of dealers;
wherein the regional part replacement forecast and a plurality of regional replacement forecasts are combined to generate a manufacturer part replacement forecast, and the manufacturer part replacement forecast is received by a manufacturer and used by the manufacturer in performing optimization of global component inventory planning and global component logistics;
wherein the plurality of regional replacement forecasts is associated with a plurality of regional distributors that provide component ordering support in regions different from a region associated with the regional distributor; and
wherein the manufacturer provides components to the regional distributor and the plurality of regional distributors.
